(19) United States
(12) Patent Application Publication
(10) Pub. No.: US 2025/0242863 A1
(43) Pub. Date: Jul. 31, 2025

(54) MODELED DYNAMICS LOW SPEED STEERING ANGLE LEARNING

(71) Applicant: Steering Solutions IP Holding Corporation, Saginaw, MI (US)

(72) Inventors: Eduardo AUDINO NOVO, Longueil-Sainte-Marie (FR); Arnaud MONTROUGE, Asnières-sur-Seine (FR); Bruno ASTARITA, Torino (IT)

(21) Appl. No.: 19/014,881

(22) Filed: Jan. 9, 2025

Related U.S. Application Data
(60) Provisional application No. 63/625,052, filed on Jan. 25, 2024.

(51) Int. Cl. B62D 15/02

(52) U.S. Cl. CPC B62D 15/022

(57) ABSTRACT

A method for calculating a handwheel angle associated with operation of a steering system of a vehicle includes calculating a plurality of handwheel angles using a plurality of respective handwheel angle calculation techniques, outputting, as results of the plurality of respective handwheel angle calculation techniques, the plurality of handwheel angles, obtaining, using the results of the plurality of respective handwheel angle calculation techniques, a combined handwheel angle output, and controlling at least one function of the steering system of the vehicle using the combined handwheel angle output.

### CROSS-REFERENCE TO RELATED APPLICATIONS

This application claims the benefit of U.S. Provisional Application No. 63/625,052, filed on Jan. 25, 2024. The entire disclosure of the application referenced above is incorporated herein by reference.

### TECHNICAL FIELD

This disclosure relates to systems and methods for estimating handwheel angle, and in particular for estimating handwheel angle under low vehicle speeds.

### BACKGROUND OF THE INVENTION

A vehicle, such as a car, truck, sport utility vehicle, crossover, mini-van, all-terrain vehicle, recreational vehicle, or other suitable forms of transportation with wheels, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like.

### SUMMARY

This disclosure relates generally to systems and methods for estimating handwheel angle under low vehicle speeds.

An aspect of the disclosed embodiments includes a method for calculating a handwheel angle associated with operation of a steering system of a vehicle. The method includes calculating a plurality of handwheel angles using a plurality of respective handwheel angle calculation techniques, outputting, as results of the plurality of respective handwheel angle calculation techniques, the plurality of handwheel angles, obtaining, using the results of the plurality of respective handwheel angle calculation techniques, a combined handwheel angle output, and controlling at least one function of the steering system of the vehicle using the combined handwheel angle output.

In another aspect, a system is configured to perform one or more functions of the various methods described herein. In another aspect, a processor is configured to execute instructions stored in memory to perform one or more functions of the various methods described herein.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1A generally illustrates a vehicle according to the principles of the present disclosure.

FIG. 1B generally illustrates a controller according to the principles of the present disclosure.

FIG. 2A generally illustrates an example rack or RWA controller and column or handwheel actuator (HWA) of a steering system according to the principles of the present disclosure.

FIG. 2B illustrates an example block diagram of a handwheel angle calculation system according to the principles of the present disclosure.

FIG. 3 is a flow diagram generally illustrating a method for estimating handwheel angle according to the principles of the present disclosure.

### DETAILED DESCRIPTION

The following discussion is directed to various embodiments of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

As described, a vehicle, such as a car, truck, sport utility vehicle, crossover, mini-van, marine craft, aircraft, all-terrain vehicle, recreational vehicle, or other suitable forms of transportation, typically includes a steering system, such as an electronic power steering (EPS) system, a steer-by-wire (SbW) steering system, a hydraulic steering system, or other suitable steering system. The steering system of such a vehicle typically controls various aspects of vehicle steering including providing steering assist to an operator of the vehicle, controlling steerable wheels of the vehicle, and the like. Although described herein with respect to vehicles, the principles of the present disclosure may also be implemented in other types of transportation or non-transportation apparatuses including steering systems.

A SbW steering system may include at least one handwheel actuator (HWA), such as a steering wheel, which is used by a driver to control the vehicle laterally, and at least one roadwheel actuator (RWA), which is used to control a steered axle of the vehicle and create lateral motion of the vehicle responsive to movement of the HWA. A SbW system may further include a controller, such as a domain controller, configured to store and execute control logic.

In EPS systems, absolute handwheel angle is a sensitive value that is used in both main steering functions (e.g., return, end of travel protection, etc.) and user/customer functions (e.g., advanced driver assistance systems, or ADAS). The handwheel angle needs to have to a certain accuracy and be available for other vehicle functions and in all driving conditions, and therefore needs to be measured or estimated with a minimum delay. There are various methods of obtaining the handwheel angle, such as measuring the handwheel angle directly using a dedicated physical absolute sensor, estimating the handwheel angle using an algorithm, etc.

Steering systems and methods according to the present disclosure are configured to establish robust, fast, and accurate absolute handwheel angle estimation techniques.

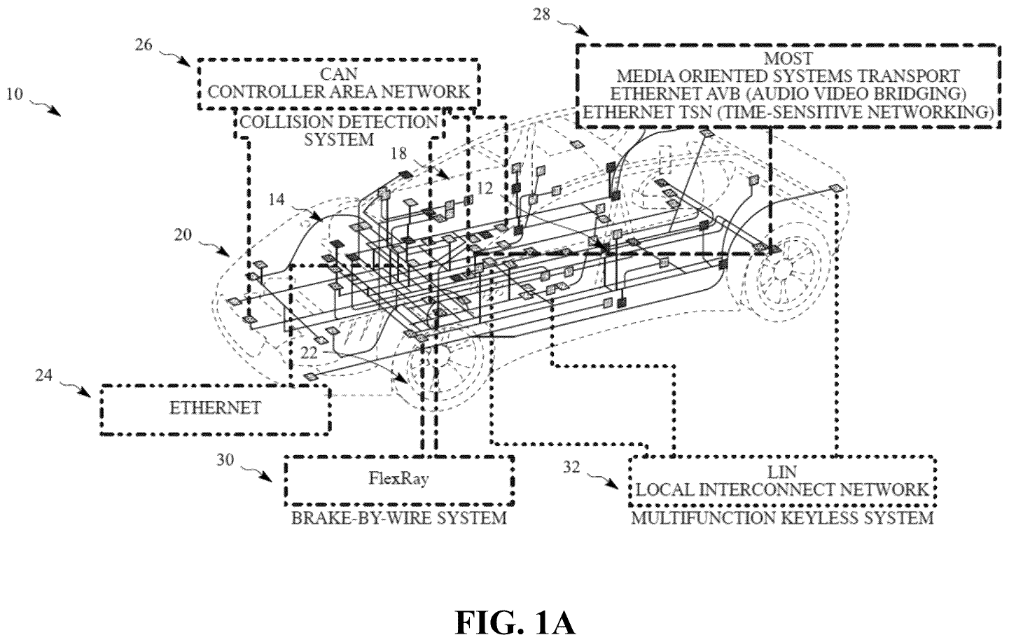

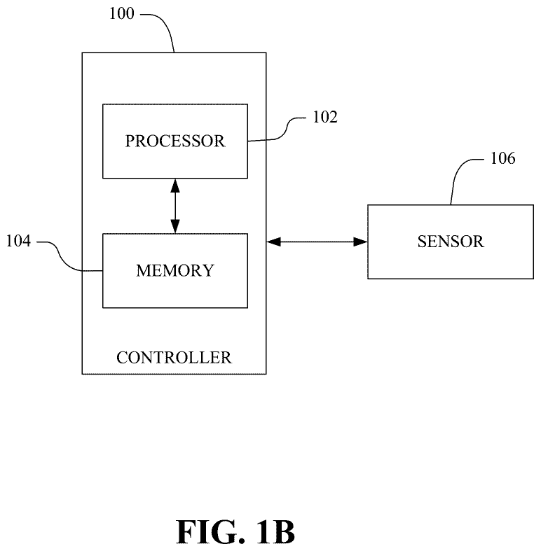

FIG. 1A generally illustrates a vehicle 10 according to the principles of the present disclosure. The vehicle 10 may include any suitable vehicle, such as a car, a truck, a sport utility vehicle, a minivan, a crossover, any other passenger vehicle, any suitable commercial vehicle, or any other suitable vehicle. While the vehicle 10 is illustrated as a passenger vehicle having wheels and for use on roads, the principles of the present disclosure may apply to other vehicles, such as planes, boats, trains, drones, or other suitable vehicles.

The vehicle 10 includes a vehicle body 12 and a hood 14. A passenger compartment 18 is at least partially defined by the vehicle body 12. Another portion of the vehicle body 12 defines an engine compartment 20. The hood 14 may be moveably attached to a portion of the vehicle body 12, such that the hood 14 provides access to the engine compartment 20 when the hood 14 is in a first or open position and the hood 14 covers the engine compartment 20 when the hood 14 is in a second or closed position. In some embodiments, the engine compartment 20 may be disposed on rearward portion of the vehicle 10 than is generally illustrated.

The passenger compartment 18 may be disposed rearward of the engine compartment 20, but may be disposed forward of the engine compartment 20 in embodiments where the engine compartment 20 is disposed on the rearward portion of the vehicle 10. The vehicle 10 may include any suitable propulsion system including an internal combustion engine, one or more electric motors (e.g., an electric vehicle), one or more fuel cells, a hybrid (e.g., a hybrid vehicle) propulsion system comprising a combination of an internal combustion engine, one or more electric motors, and/or any other suitable propulsion system.

In some embodiments, the vehicle 10 may include an electric, hybrid or a petrol or gasoline fuel engine, such as a spark ignition engine. In some embodiments, the vehicle 10 may include a diesel fuel engine, such as a compression ignition engine. The engine compartment 20 houses and/or encloses at least some components of the propulsion system of the vehicle 10. Additionally, or alternatively, propulsion controls, such as an accelerator actuator (e.g., an accelerator pedal), a brake actuator (e.g., a brake pedal), a handwheel, and other such components are disposed in the passenger compartment 18 of the vehicle 10. The propulsion controls may be actuated or controlled by an operator of the vehicle 10 and may be directly connected to corresponding components of the propulsion system, such as a throttle, a brake, a vehicle axle, a vehicle transmission, and the like, respectively. In some embodiments, the propulsion controls may communicate signals to a vehicle computer (e.g., drive by wire) which in turn may control the corresponding propulsion component of the propulsion system. As such, in some embodiments, the vehicle 10 may be an autonomous vehicle.

In some embodiments, the vehicle 10 includes a transmission in communication with a crankshaft via a flywheel or clutch or fluid coupling. In some embodiments, the transmission includes a manual transmission. In some embodiments, the transmission includes an automatic transmission. The vehicle 10 may include one or more pistons, in the case of an internal combustion engine or a hybrid vehicle, which cooperatively operate with the crankshaft to generate force, which is translated through the transmission to one or more axles, which turns wheels 22. When the vehicle 10 includes one or more electric motors, a vehicle battery, and/or fuel cell provides energy to the electric motors to turn the wheels 22.

The vehicle 10 may include automatic vehicle propulsion systems, such as a cruise control, an adaptive cruise control, automatic braking control, other automatic vehicle propulsion systems, or a combination thereof. The vehicle 10 may be an autonomous or semiautonomous vehicle, or other suitable type of vehicle. The vehicle 10 may include additional or fewer features than those generally illustrated and/or disclosed herein.

In some embodiments, the vehicle 10 may include an Ethernet component 24, a controller area network (CAN) bus 26, a media-oriented systems transport component (MOST) 28, a FlexRay component 30 (e.g., brake-by-wire system, and the like), and a local interconnect network component (LIN) 32. The vehicle 10 may use the CAN bus 26, the MOST 28, the FlexRay component 30, the LIN 32, other suitable networks or communication systems, or a combination thereof to communicate various information from, for example, sensors within or external to the vehicle, to, for example, various processors or controllers within or external to the vehicle. The vehicle 10 may include additional or fewer features than those generally illustrated and/or disclosed herein.

In some embodiments, the vehicle 10 may include a steering system, such as an EPS system, a steering-by-wire steering system (e.g., which may include or communicate with one or more controllers that control components of the steering system without the use of mechanical connection between the handwheel and wheels 22 of the vehicle 10), a hydraulic steering system (e.g., which may include a magnetic actuator incorporated into a valve assembly of the hydraulic steering system), or other suitable steering system.

The steering system may include an open-loop feedback control system or mechanism, a closed-loop feedback control system or mechanism, or combination thereof. The steering system may be configured to receive various inputs, including, but not limited to, a handwheel position, an input torque, one or more roadwheel positions, other suitable inputs or information, or a combination thereof.

Additionally, or alternatively, the inputs may include a handwheel torque, a handwheel angle, a motor velocity, a vehicle speed, an estimated motor torque command, other suitable input, or a combination thereof. The steering system may be configured to provide steering function and/or control to the vehicle 10. For example, the steering system may generate an assist torque based on the various inputs. The steering system may be configured to selectively control a motor of the steering system using the assist torque to provide steering assist to the operator of the vehicle 10. The steering system of the present disclosure is configured to implement handwheel estimation systems and methods as described below in more detail.

In some embodiments, the vehicle 10 includes one or more controllers, such as controller 100, as is generally illustrated in FIG. 1B. The controller 100 may correspond to a steering system controller. The controller 100 may include any suitable controller, such as an electronic control unit or other suitable controller. The controller 100 may be configured to control, for example, the various functions of the steering system and/or various functions of the vehicle 10. The controller 100 may include a processor 102 and a memory 104. The processor 102 may include any suitable processor, such as those described herein. Additionally, or alternatively, the controller 100 may include any suitable number of processors, in addition to or other than the processor 102. The memory 104 may comprise a single disk or a plurality of disks (e.g., hard drives), and includes a storage management module that manages one or more partitions within the memory 104. In some embodiments, memory 104 may include flash memory, semiconductor (solid state) memory or the like. The memory 104 may include Random Access Memory (RAM), a Read-Only Memory (ROM), or a combination thereof. The memory 104 may include instructions that, when executed by the processor 102, cause the processor 102 to, at least, control various aspects of the vehicle 10. Additionally, or alternatively, the memory 104 may include instructions that, when executed by the processor 102, cause the processor 102 to perform functions associated with the systems and methods described herein.

The controller 100 may receive one or more signals from various measurement devices or sensors 106 indicating sensed or measured characteristics of the vehicle 10. The sensors 106 may include any suitable sensors, measurement devices, and/or other suitable mechanisms. For example, the sensors 106 may include one or more torque sensors or devices, one or more handwheel position sensors or devices, one or more motor position sensor or devices, one or more position sensors or devices, other suitable sensors or devices, or a combination thereof. The one or more signals may indicate a handwheel torque, a handwheel angle, a motor velocity, a vehicle speed, other suitable information, or a combination thereof. The one or more signals may indicate a handwheel torque, a handwheel angle, a motor velocity, a vehicle speed, other suitable information, or a combination thereof. As used herein, “sensors” may correspond to physical sensors or derived signals (e.g., signals derived from algorithms or calculations based on one or more sensor inputs both directly into the controller or using data communicated to the controller from sources outside the immediate controller area).

As used herein, “controller” may refer to a hardware module or assembly including one or more processors or microcontrollers, memory, sensors, one or more actuators, a communication interface, etc., any portions of which may be collectively referred to as “circuitry.” As described herein, respective functions and steps performed by a given controller, control circuitry, etc. may be collectively performed by multiple controllers, processors, etc. For example, a processor, processing device, controller, control circuitry, etc. “configured to perform” may refer to a single processor, processing device, controller, etc. configured to perform both A and B or may refer to a first processor, processing device, controller, etc. configured to perform A and a second processor, processing device, controller, etc. configured to perform B. For simplicity, “control circuitry configured to perform A and B” may refer to a single or multiple processors, processing devices, controllers, etc. collectively configured to perform A and B. In some examples, one or more functions may be performed remotely (e.g., relative to the vehicle), such as at a controller, processor, circuitry, etc. of a remote server, cloud computing system, and/or other remote processing system.

In some embodiments, the controller 100 may perform the methods described herein. However, the methods described herein as performed by the controller 100 are not meant to be limiting, and any type of software executed on a controller, processor, or other circuitry can implement the hysteresis shaping techniques described herein without departing from the scope of this disclosure. For example, a controller, such as a processor executing software within a computing device, may be configured to implement the systems and methods described herein.

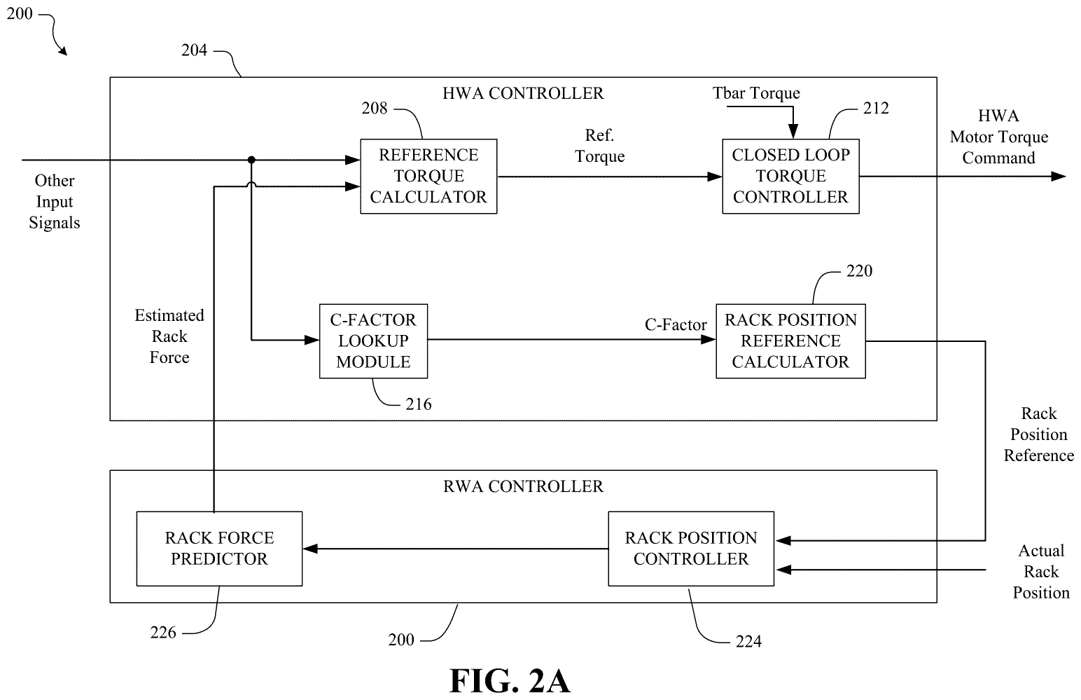

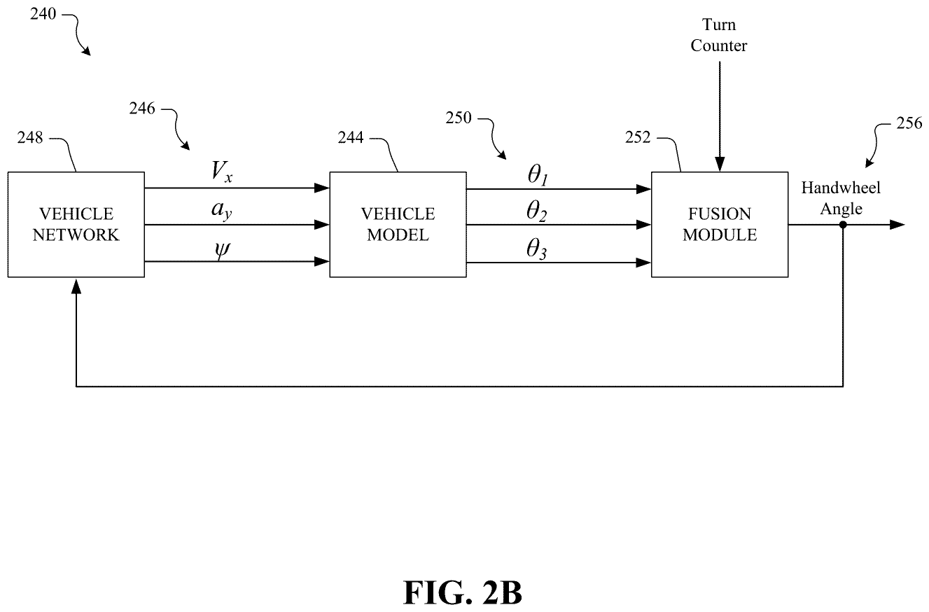

FIG. 2A illustrates an example steering system 200 including a rack or RWA controller 202 and column or handwheel actuator (HWA) controller 204 of a steering system configured to implement handwheel estimation techniques according to the present disclosure. The HWA controller 204 is configured to generate a handwheel actuator (HWA) motor torque command based on an estimated rack force (e.g., an estimated rack force signal) received from the RWA controller 202 and one or more other input signals (e.g., vehicle speed, handwheel position, and handwheel velocity). The RWA controller 202 is configured to determine the estimated rack force based on the motor torque required to achieve or maintain an actual rack position. The controllers 200 and 204 may correspond to, be implemented by, etc. one or more steering system controllers.

As one example, the HWA controller 204 includes a reference torque calculator 208 configured to calculate a reference torque (T_{ref}) based on the estimated rack force and the one or more other input signals. For example, the reference torque corresponds to a sum of various inputs/measurements such as effort, hysteresis, return correction or CVR, damping, catch, etc. A closed loop (e.g., a PID closed loop) torque controller 212 is configured to generate and output the motor torque command based at least in part on a force or torque applied by the driver (e.g., “Tbar torque”) and the reference torque. The motor torque command is provided as a control signal to control a motor of the handwheel actuator.

The estimated rack force corresponds to the measured or estimated roadwheel actuator motor torque. Accordingly, the estimated rack force (and any estimated rack force offset or error) is a critical factor for determining the force provided by the motor of the handwheel actuator.

In some examples, the HWA controller 204 may further include a C-factor lookup module 216 and a rack position reference calculator 220. For example, the rack position reference calculator 220 is configured to generate the rack position reference based on a C-factor received from the C-factor lookup module 216. The C-factor may be determined based on a handwheel angle (“HwAg”) corresponding to driver input (e.g., a handwheel angle indicating driver intent conveyed via the handwheel). Example systems and methods for obtaining the rack position reference and the C-factor are described in more detail in U.S. patent application Ser. No. 18/318,657, filed on May 16, 2023, the entire contents of which are incorporated herein by reference.

The RWA controller 202 includes a rack position controller 224 (e.g., a PID rack position controller) configured to generate one or more rack position control signals based on the actual rack position and the rack position reference (e.g., based on a difference between the actual rack positon and the rack position reference). For example, the rack position control signals may include, but are not limited to, rack motor velocity and motor torque command (e.g., indicative of an amount of torque applied by the driver) signals. In this manner, rack position is controlled to follow the intent of the driver (as indicated by the rack reference position).

A rack force predictor 226 generates the estimated rack force based on outputs of the rack position controller 224 (e.g., based on a function of the rack motor velocity, the rack motor torque command, etc.). In various examples, the estimated rack force may be calculated based on the amount of torque applied to the handwheel by the driver (as indicated by the rack motor torque command, various sensor signals, etc.). As shown, the rack force predictor 226 may output the estimated rack force and the reference torque calculator 208 (and/or another component of the RWA controller 202, the HWA controller 204, etc.) may obtain an estimated rack load based on the estimated rack force. In other examples, the rack force predictor 226 may output the estimated rack load. In some contexts, the terms “estimated rack force” and “estimated rack load” may be used interchangeably.

For example, for RWA position control, the rack position reference signal (“RackPosRef”) may be calculated based on a position error (“PosErr”) between an ADAS rack position reference value or signal (“ADASRackPosRef”) and an HWA rack position reference value or signal (“HWARackPosRef”). Conversely, HWA position control is based on a position error between the HWA position and the RWA position, such that the handwheel can be controlled to rotate in a manner consistent with rotation of the roadwheel in hands-off conditions.

The reference torque may correspond to a desired, ideal, or target torque to be felt by the driver (i.e., at the handwheel/steering wheel). As described above, the reference torque is calculated based on inputs including, but not limited to, driver input (e.g., an input torque, corresponding to steering handwheel angle), road conditions, damping, hysteresis, etc. A torque at the handwheel is controlled (e.g., via the HWA) to match the reference torque. For example, outputs of one or more sensors measuring actual torque at the wheel are used to minimize the difference between the reference torque and the actual torque.

An effort function (e.g., an effort function implemented by the reference torque calculator 208) defines a relationship between driver input (e.g., the force or torque applied by the driver to the handwheel, which may be referred to as “effort”) and a response (i.e., movement) of the steering system. For example, the effort function may output an effort value based on a lookup table or other function (e.g., by using an estimated rack load as an input). The estimated rack load may be modified prior to being input to the lookup table by adding a calculated return load value to the estimated rack load. The effort function indicates an amount of effort required by the driver to cause a desired response.

Steering systems and methods (e.g., the steering system 200) according to the present disclosure is configured to implement handwheel angle estimation techniques as described below in more detail.

Steering systems and methods according to the present disclosure are configured to provide EPS handwheel angle calculation with flexible and less restrictive conditions for driving the vehicle. One example objective of the system is to complete an accurate estimation in a short driving time in low minimum vehicle speed conditions (e.g., at parking speed, during driving maneuvers (which may include straight and turning vehicle conditions) and with a sufficient accuracy to be used by other vehicle ECUs. As an example, systems and methods of the present disclosure implement a fusion of calculations from model-based designs to estimate an accurate and robust handwheel absolute angle.

The systems and methods of the present disclosure are configured to implement a fusion of three calculation strategies/techniques corresponding to respective driving modes or conditions: vehicle wheel speed vectoring (e.g., corresponding to low driving speeds/steering angles, such as speeds/steering angles associated with leaving and/or entering a parking space); a vehicle yaw rate measurement-based calculation (e.g., corresponding to straight line driving; and pinion torque profiling calculation (e.g., corresponding to dynamic steering conditions).

For vehicle wheel speed vectoring calculation, each individual wheel is composed of a longitudinal speed/velocity (Vₓ) and lateral speed/velocity (V_{y}) while cornering, which can be expressed as V_{w} (e.g., a total speed vector corresponding to each individual wheel speed as transmitted through a vehicle network by the ESC system). While driving straight, a full vehicle average speed Vᵥ corresponds to the four individual wheel speeds V_{w}. While cornering, each individual wheel speed V_{w} (for respective wheels 1, 2, 3 and 4) will proportionally evolve to describe the vehicle trajectory, while the total vehicle average speed is represented by a vector placed at the vehicle center of gravity.

Therefore, vehicle wheel speed vectoring calculation is based on the evolution of the variation of the angle around the vertical vehicle axis representing the vehicle speed vector trajectory translated by each of the wheel speeds vectors. A total average vehicle speed vector, which varies in accordance to the yaw rate, is calculated to enhance accuracy instead of simply being based on yaw rate measurement. For example, yaw rate measurement alone is a consequence of a vehicle cornering movement and therefore may be too late as an information source for accurate, real-time estimation of handwheel angle.

Vehicle wheel speed vectoring calculation may be limited within the linear tire load build-up response and is particularly efficient at lower vehicle speeds, and can be used with greater steering angles/yaw rates (e.g., a yaw rate greater than 0, between 0 and 0.5, etc.). In some examples, various conditions may be filtered while brakes systems are operating to correct trajectory. Accordingly, the vehicle wheel speed vectoring calculation may be implemented by the systems and methods described herein in response to one or more conditions associated with low speed driving, leaving/entering a parking, space, etc. are met (e.g., a vehicle speed less than a threshold, such as 10 kph, and a non-zero steering angle).

For straight line driving calculation, various assumptions may be made, such as a vehicle speed greater than or equal to a threshold associated with the vehicle wheel speed vectoring calculation (e.g., greater than or equal to 10 kph) and small steering angles/yaw rates (e.g., a yaw rate or steering angle of approximately 0, less than a steering threshold, etc.). For example, in straight line driving conditions, lateral acceleration (and therefore tire slip angle) can be considered negligible, allowing an assumption that tire lateral forces are equal to 0. Similarly, load transfers on roll and pitch axles can be considered negligible, facilitating assessment of a single wheel on front and rear axles.

Consequently, a simple kinematic bicycle model can be used to estimate an absolute front steering wheel angle based on a measurement of yaw rate (e.g., a measurement of yaw rate obtained from an electronic stability control (ESC) system (e.g., an ESC system in communication with a vehicle brakes controller).

As one example, a yaw rate expression for a yaw rate y can be obtained in accordance with:

$$ψ = \frac{V}{{a}_{1}} sin ( β ( δ ) ) ,$$

where V=Vₓ (a longitudinal speed) due to negligible lateral motion on a straight line, a₁ corresponds to a distance from a front wheel to vehicle center of gravity, β corresponds to a slip angle at the vehicle center of gravity, and δ corresponds to a front steer angle.

Further,

$$β ( δ ) = {tan}^{- 1} ( tan ( δ ) * \frac{{a}_{2}}{{a}_{2} + {a}_{1}} ) ,$$

where a₂ corresponds to a distance from a rear wheel to a center of gravity.

Therefore:

$$ψ = \frac{V}{{a}_{1}} sin ( {tan}^{- 1} ( tan ( δ ) * \frac{{a}_{2}}{{a}_{2} + {a}_{1}} ) ) .$$

Simplifying as a₁=a₂ (i.e., a mass repartition of 50% rear and 50% front), which is valid for strict straight-line driving, the front steer angle can be approximated in accordance with:

$$δ = 2 * {sin}^{- 1} ( \frac{{a}_{1}}{{V}_{x}} ψ ) .$$

The front steer angle can then be converted into handwheel angle based on a front steer ratio. Accuracy of the calculation of the handwheel angle in this manner increases as vehicle speed increases.

In dynamic steering conditions (e.g., corresponding to the pinion torque profiling calculation), the rack loads are proportionally increasing with rack travel and thus are directly related to handwheel angle. As used herein, dynamic steering may correspond to conditions where yaw rate/steering angle are greater than 0, greater than the steering threshold associated with the straight line driving calculation, etc. A rack load being balanced by the driver torque added to EPS motor assistance torque are represented by pinion torque. Accordingly, pinion torque profiling calculation includes linearizing (e.g., using low pass filters) and then applying progressively sliding learning windows to compare variation in pinion torque to variation in steering assistance motor position.

As a steering rack travels, a steering ratio (e.g., a ratio of pinion torque, which is based on driver torque, motor assistance torque, etc., to motor position) corresponds to known calibratable constants. Accordingly, the pinion torque profile variation relates to a matching assistance motor variation compared to calibratable templates to output a handwheel angle estimation that is especially efficient at close to end-of-travel and near-center positions and at very low vehicle speeds. As one example, pinion torque is obtained (e.g., based on at least the driver torque and motor assistance torque), the steering ratio is obtained based on the pinion torque (e.g., based on the pinion torque and motor position), and the handwheel angle is obtained based on the steering ratio (e.g., using a lookup table that correlates steering ratio to handwheel angle.

Fusion source arbitration according to the present disclosure fuses results of the straight line driving calculation, vehicle wheel speed vectoring calculation, and pinion torque profiling calculation. Upon completion of these three calculation methods, arbitration is applied with a dynamically evolving weight for each calculation method and the results are averaged into a final, comprehensive output.

While observing the driving conditions with respect to yaw rate variation, lateral acceleration variation, driver torque, vehicle speed, and handwheel velocity, the arbitration adapts weighting priorities for the various calculation methods based on which calculation method is better suitable for specific driving conditions and dynamically and averages the weighted outputs together. The systems and methods may also receive other inputs, such as an input from a motor sensor turns counter, to calculate steering movements during periods in which the steering system is not activated.

Each of the calculation methods described herein comprise part of a vehicle simplified model and therefore incorporate a modeled dynamics learning process.

One aspect of the principles of the present disclosure is the adaptive operation of the arbitration between calculation methods, which identifies a balanced/optimized proportion among the three calculation methods at each instant and implements a calibratable rate evolution accordingly. Balancing/weighting criteria for the three calculation methods may be based on calibrations to allow tuning adaptability for different vehicle architectures.

As described herein, the principles of the present disclosure combine steering assistance information, vehicle movement modeling, and fusion data to provide optimized handwheel angle estimation construction in a quick and reliable method. In an example, all handwheel angle calculation resides within a steering assistance controller (e.g., EPS system controller). Therefore, handwheel angle calculation according to the present disclosure benefits from a high refresh rate of the internal EPS signals, such as the pinion torque, motor position, driver torque, as well as lower frequency events such as the vehicle yaw and lateral acceleration. In this manner, handwheel angle calculation/estimation is optimized to achieve high accuracy and response time. The dynamically evolving arbitration implemented for fusion of the results of the calculation methods ensures robustness and enhanced accuracy.

FIG. 2B generally illustrates an example block diagram of a handwheel angle calculation system 240 according to the present disclosure. For example, the system 200, such as the HWA controller 204, may implement one or more functions/components of the handwheel angle calculation system 240.

A vehicle model 244 receives various vehicle signals 246 as described above (e.g., from a vehicle network 248, via a CAN bus). The vehicle signals 246 may include various measurements, sensed or calculated values, etc. corresponding to handwheel angle and may include, but are not limited to, one or more longitudinal vehicle speeds Vₓ, distances a_{y} between respective wheels and the vehicle center of gravity, and a yaw rate ψ.

The vehicle model 244 is configured to implement/execute various (e.g., two or more) calculation methods/techniques for calculating handwheel angle as described herein. For example, the vehicle model 244 may be configured to perform each of a straight line driving calculation, a vehicle wheel speed vectoring calculation, and a pinion torque profiling calculation as described above and output respective results 250 of each of the calculations (e.g., as respective handwheel angles θ₁, θ₂, and θ₃).

A fusion module or circuit 252 configured to perform one or more angle/result arbitration techniques receives the results 250 (e.g., the respective handwheel angles θ₁, θ₂, and θ₃) of the different calculation methods and generates an angle output (e.g., an angle offset) by weighting and/or averaging the results 250 from the different calculation methods as described above. For example, the fusion module 252 is configured to obtain or calculate respective weights for each of the calculation methods and apply the weights to the results 250. For example, a total of the respective weights may equal 1. In some examples, the respective weights may be approximately equal (i.e., the fusion module 252 calculates a direct average of the three results 250). In other examples, the respective weights are different. In some examples, one or more of the results 250 may be assigned a weight of 0. The weights may be fixed, vary in accordance with one or more vehicle conditions, inputs, operating parameters or characteristics (e.g., vehicle speed), etc. In some examples, the fusion module 252 may generate/apply the weights further based on an input from a motor sensor turn counter (e.g., a turn counter value).

In this manner, the results 250 are combined into a handwheel angle output 256. The system 200 is configured to control one or more functions of the steering system of the vehicle based on the handwheel angle output 256 as described above in FIG. 2A (e.g., various functions associated with handwheel angle/driver input).

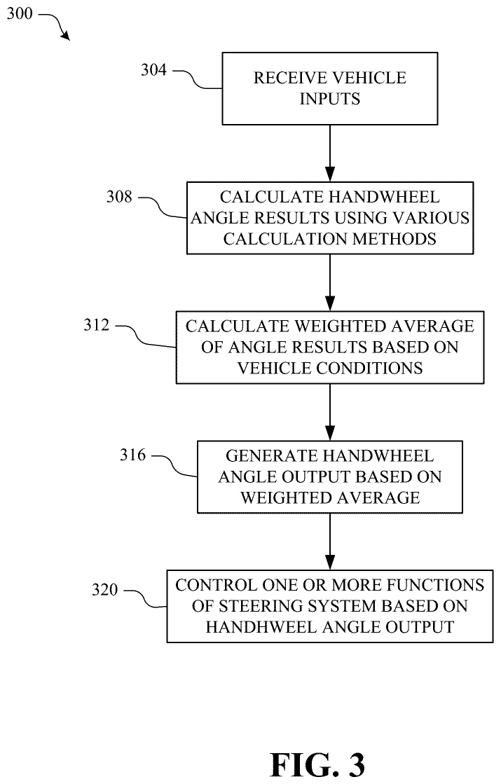

FIG. 3 is a flow diagram generally illustrating a method 300 for performing handwheel angle calculation/estimation techniques according to the principles of the present disclosure. For example, one or more computing devices, processors, or processing devices, etc. are configured to execute instructions to implement the method 300, such as one or more of the processors of the systems described herein (e.g., a computing device or processor of a vehicle configured to implement the controller 100, the system 200, etc.). One or more of the steps of the method 300 as described below may be skipped or omitted in some examples, and/or one or more of the steps may be performed in a different sequence than described.

At 304, the method 300 includes receiving (e.g., at a vehicle model as described herein) one or more inputs related to operation of a vehicle steering system. The inputs may include, but are not limited to, one or more speeds (e.g., longitudinal wheel speeds), a yaw rate, and a distance between a wheel and a vehicle center of gravity.

At 308, the method 300 includes executing/performing various calculation methods/techniques (e.g., a straight line driving calculation, a vehicle wheel speed vectoring calculation, and a pinion torque profiling calculation as described above) and outputting respective angle results for each of the calculation methods.

At 312, the method 300 includes dynamically calculating a weighted average of the respective angle results by generating and applying respective weights to the results of each of the calculations/methods. For example, the weights may be calculated based in part on vehicle conditions/behavior as described above in more detail. As one example, the weights are calculated based on comparisons to various conditions/thresholds associated with each of the calculations/modes. For example, vehicle conditions/characteristics indicative of whether the vehicle is leaving/entering a parking space, driving straight at speeds greater than speeds associated with leaving/entering a parking space, or dynamically steering (e.g., vehicle speeds, yaw rates/steering angles, etc.) are compared to respective thresholds, ranges of values, and so on.

As one example, in a situation where vehicle speed is low (less than 10 kph) and steering angle is high (e.g., greater than a steering threshold, such as a yaw rate of 0.5), a weight of 1 may be assigned to the vehicle wheel speed vectoring calculation while a weight of 0 is assigned to straight line driving and pinion torque profiling calculations. Conversely, in a situation where vehicle speed is high (e.g. greater than 10 kph) and steering angle is low (e.g., less than a steering threshold, such as a yaw rate of 0.5), a weight of 1 may be assigned to the straight line driving calculation while a weight of 0 is assigned to vehicle wheel speed vectoring and pinion torque profiling calculations. In in a situation where steering angle dynamically changing (e.g., yaw rate/steering angle is increasing and/or decreasing during a given sample window), a weight of 1 may be assigned to the pinion torque profiling calculation while a weight of 0 is assigned to vehicle wheel speed vectoring and vehicle wheel speed vectoring calculations. While this examples including weights of only 1 or 0 are simplified for illustration purposes, the weights may vary in different conditions (e.g., a weight of 1 may be assigned to a given calculation and decrease as the conditions approach thresholds associated with other conditions, while a weight of 0 may be assigned to another calculation and increase as the conditions approach thresholds associated with that condition). Accordingly, conditions may occur where the assigned weights are 0.05, 0.5 and 0; 0.5, 0.25, and 0.25; 0.75, 0.25, and 0; 0.33, 0.33, and 0.33; etc.

At 316, the method 300 includes generating an overall/combined handwheel angle output based on the weighted average. At 320, the method 300 includes controlling one or more functions of the steering system based on the handwheel angle output.

For example, handwheel angle may be used for implementing and/or controlling various functions or calculations, such as return, end of travel protection, ADAS functions, etc. As one example, handwheel angle can be used to calculated/obtain other values or inputs, including, but not limited to, handwheel angle, handwheel speed, handwheel torque, etc., which are in turn used to implement various control functions.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same embodiment or implementation unless described as such. As used herein, the term “approximately” may correspond to within “+/−5.0% of.”

Implementations the systems, algorithms, methods, instructions, etc., described herein can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors, or any other suitable circuit. In the claims, the term “processor” should be understood as encompassing any of the foregoing hardware, either singly or in combination. The terms “signal” and “data” are used interchangeably.

As used herein, the term module can include a packaged functional hardware unit designed for use with other components, a set of instructions executable by a controller (e.g., a processor executing software or firmware), processing circuitry configured to perform a particular function, and a self-contained hardware or software component that interfaces with a larger system. For example, a module can include an application specific integrated circuit (ASIC), a Field Programmable Gate Array (FPGA), a circuit, digital logic circuit, an analog circuit, a combination of discrete circuits, gates, and other types of hardware or combination thereof. In other embodiments, a module can include memory that stores instructions executable by a controller to implement a feature of the module.

Further, in one aspect, for example, systems described herein can be implemented using a general-purpose computer or general-purpose processor with a computer program that, when executed, carries out any of the respective methods, algorithms, and/or instructions described herein. In addition, or alternatively, for example, a special purpose computer/processor can be utilized which can contain other hardware for carrying out any of the methods, algorithms, or instructions described herein.

Further, all or a portion of implementations of the present disclosure can take the form of a computer program product accessible from, for example, a computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

The above-described embodiments, implementations, and aspects have been described in order to allow easy understanding of the present invention and do not limit the present invention. On the contrary, the invention is intended to cover various modifications and equivalent arrangements included within the scope of the appended claims, which scope is to be accorded the broadest interpretation so as to encompass all such modifications and equivalent structure as is permitted under the law.

What is claimed is:

1. A method for calculating a handwheel angle associated with operation of a steering system of a vehicle, the method comprising:
calculating a plurality of handwheel angles using a plurality of respective handwheel angle calculation techniques;
outputting, as results of the plurality of respective handwheel angle calculation techniques, the plurality of handwheel angles;
obtaining, using the results of the plurality of respective handwheel angle calculation techniques, a combined handwheel angle output; and
controlling at least one function of the steering system of the vehicle using the combined handwheel angle output.

2. The method of claim 1, wherein the plurality of respective handwheel angle calculation techniques includes two or more of a straight line driving calculation, a vehicle wheel speed vectoring calculation, and a pinion torque profiling calculation.

3. The method of claim 1, wherein obtaining the combined handwheel angle output includes (i) obtaining respective weights for each of the results and (ii) calculating the combined handwheel angle output using the respective weights.

4. The method of claim 1, wherein obtaining the combined handwheel angle output includes averaging the results.

5. The method of claim 1, wherein calculating the plurality of handwheel angles includes calculating at least a first handwheel angle of the plurality of handwheel angles based on a yaw rate of the vehicle.

6. The method of claim 1, wherein calculating the plurality of handwheel angles includes calculating at least a first handwheel angle of the plurality of handwheel angles based on distance between a wheel and a center of gravity of the vehicle.

7. The method of claim 1, wherein calculating the plurality of handwheel angles includes calculating at least a first handwheel angle of the plurality of handwheel angles based on front steer rate of the vehicle.

8. The method of claim 1, wherein obtaining the combined handwheel angle output includes obtaining the combined handwheel angle output based on an input from a motor sensor turns counter.

9. The method of claim 1, wherein the at least one function of the steering system includes a driver assistance function.

10. A system for calculating a handwheel angle associated with operation of a steering system of a vehicle, the system comprising:
a processor configured to execute instructions stored in memory, wherein executing the instructions causes the processor to
calculate a plurality of handwheel angles using a plurality of respective handwheel angle calculation techniques,
output, as results of the plurality of respective handwheel angle calculation techniques, the plurality of handwheel angles,
obtain, using the results of the plurality of respective handwheel angle calculation techniques, a combined handwheel angle output, and
control at least one function of the steering system of the vehicle using the combined handwheel angle output.

11. The system of claim 10, wherein the plurality of respective handwheel techniques includes two or more of a straight line driving calculation, a vehicle wheel speed vectoring calculation, and a pinion torque profiling calculation.

12. The system of claim 10, wherein obtaining the combined handwheel angle output includes (i) obtaining respective weights for each of the results and (ii) calculating the combined handwheel angle output using the respective weights.

13. The system of claim 10, wherein obtaining the combined handwheel angle output includes averaging the results.

14. The system of claim 10, wherein calculating the plurality of handwheel angles includes calculating at least a first handwheel angle of the plurality of handwheel angles based on a yaw rate of the vehicle.

15. The system of claim 10, wherein calculating the plurality of handwheel angles includes calculating at least a first handwheel angle of the plurality of handwheel angles based on distance between a wheel and a center of gravity of the vehicle.

16. The system of claim 10, wherein calculating the plurality of handwheel angles includes calculating at least a first handwheel angle of the plurality of handwheel angles based on front steer rate of the vehicle.

17. The system of claim 10, wherein obtaining the combined handwheel angle output includes obtaining the combined handwheel angle output based on an input from a motor sensor turns counter.

18. The system of claim 10, wherein the at least one function of the steering system includes a driver assistance function.

19. A system for calculating a handwheel angle associated with operation of a steering system of a vehicle, the system comprising:
a handwheel actuator configured to
calculate a plurality of handwheel angles using a plurality of respective handwheel angle calculation techniques, the respective handwheel angle calculation techniques including two or more of a straight line driving calculation, a vehicle wheel speed vectoring calculation, and a pinion torque profiling calculation,
output, as results of the plurality of respective handwheel angle calculation techniques, the plurality of handwheel angles,
obtain, using the results of the plurality of respective handwheel angle calculation techniques, a combined handwheel angle output by combining the results of the plurality of respective handwheel angle calculation techniques, and
control at least one function of the steering system of the vehicle using the combined handwheel angle output.

20. The system of claim 19, wherein obtaining the combined handwheel angle output includes at least one of averaging the results, calculating a weighted average of the results, and omitting one or more of the results.
